(19) United States
(12) Patent Application Publication
(10) Pub. No.: US 2003/0079626 A1
(43) Pub. Date: May 1, 2003

(54) Mail canceling apparatus and mail stacking apparatus

(75) Inventor: Kazuhito Yoshitani, Minato-Ku (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/283,058

(22) Filed: Oct. 30, 2002

(30) Foreign Application Priority Data
Oct. 31, 2001 (JP) 334400/2001

(51) Int. Cl. B41K 1/00

(52) U.S. Cl. 101/71

(57) ABSTRACT

In a mail canceling apparatus 1, a stacking unit 30 includes a pinch roller arrangement 31, an entrance sensor 32, a bottom member 33 for stacking mail pieces 60 thereon, a guide 34, a rotor 35, a position sensor 36 for detecting the rotational position of the rotor 35, a depression sensor 37 for detecting the depression of the rotor 35, a paddle 38, first stacking belts 39 and second stacking belts 40. When a mail piece 60 is stacked, an entrance space 41 is secured for the next mail piece 60.

### BACKGROUND OF THE INVENTION

This application claims benefit of Japanese Patent Application No. 2001-334400 filed on Oct. 31, 2001, the contents of which are incorporated by the reference.

The present invention relates to mail canceling apparatuses and mail stacking apparatus and, more particularly, to mail canceling apparatus and mail stacking apparatus, capable of stacking mail pieces having different sizes and thicknesses without possibility of occurrence of jamming (or detective stacking).

A prior art mail canceling apparatus for canceling postal matter or the like operates to cancel (such as impressing postal cancel on) postal cards and envelopes of the usual sizes, and is provided with a stacking unit for stacking canceled postal mater or the like. The stacking unit is usually of a pull-in roller type, and can stack postal cards, small size thin envelopes, etc. By the term “mail pieces are referred to postal cards, envelopes, flats, rectangular sacks containing documents or the like, and so forth hereinafter.

FIG. 7 is a schematic top view for explaining a pull-in roller type stacker in a prior art mail canceling apparatus. Referring to the Figure, the mail canceling apparatus 100 comprises a feeder unit 10, a canceling unit 20, a pull-in roller type stacking unit 30, and a control unit 50 operable for feed control to determine a canceling position. To facilitate the understanding, the top cover of the stacking unit 130 is omitted and not shown.

The feeder unit 10 includes an input feeder 11, in which the mail pieces 60 as the subject of canceling are set. The operator places the mail pieces 60 in a uniform front/back and up/down state on the input feeder 11. When a feed switch (not sown) is turned on, the feeder unit 10 transmits the mail pieces 60 one by one to the canceling unit 20.

The canceling unit 20 includes a canceling mechanism (not shown) for executing canceling at a designated position and feed rollers 21 for feeding the mail pieces 60 to the stacking unit 130. The canceling unit 20 is controlled by the control unit 50 to cancel the mail pieces 60 at a predetermined position thereof, and the feed rollers 21 feeds the canceled mail pieces 60 to the downstream side stacking unit 130.

The pull-in type stacking unit 130 includes a bottom member 131, a guide 132 disposed on the bottom member 131 on the upstream side thereof, a pull-in roller 133 capable of projecting in rotation from an opening in the guide 132, a paddle 134 for supporting stacked mail pieces 60, and a side member 135 for receiving the pulled-in mail pieces 60.

The height of the bottom member 131 is set to be substantially the same as the feeding height of the feed rollers 21, i.e., the height of the input of the stacking unit 130. Mail pieces 60 are thus fed in the horizontal direction by the feed rollers 21.

The first mail piece 60 is pulled in, in a state that it is sandwiched between the paddle 134 and the guide 132 and transversally upright, by a pull-in roller 134, which is rotated at all times, until it is brought into contact with the side member 135. The second mail piece 60 is likewise stacked by being pulled in between the precedingly stacked mail piece 60 and the guide 132. In this way, in the pull-in roller type stacking unit 130, when a new mail piece 60 is tacked, the paddle 134 is moved to the downstream side of the bottom member 131. In this way, it is possible to continuously stack a plurality of mail pieces 60.

The above mail canceling apparatus 100, however, has a problem that in the pull-in type stacking unit 130 the pull-in roller 133 which is rotating at all times is deemed to be in continuous contact with the mail piece 60 to be stacked, thus giving rise to the possibility of scratching or breaking of the mail piece 60.

Another problem residing in the stacking unit 130 is that since mail pieces 60 are pulled in by the pull-in roller 133 which is rotating at all times, it is impossible to stack the mail pieces of different sizes and thicknesses without possibility of occurrence of jamming (or defective stacking).

A further problem residing in the stacking unit 130 is that a bent mail piece 60 may be brought into contact with the precedingly stacked mail piece 60 and become unable to be moved in the horizontal direction, so that it can no longer be stacked.

A still further problem residing in the stacking unit 130 is that, depending on the state of warping or bending hardness of the inlet side end part of the precedingly stacked mail piece 60, the leading end of a new mail piece 60 to be stacked may be brought into contact with the inlet side end part of the precedignly stacked mail piece 60, thus resulting in jamming (or detective stacking).

The stacking unit 130 further has a drawback that it can not stack a mail piece 60, which has such thickness that it is unable to enter the space between the inlet side end part of the precedingly stacked mail piece 60 and the guide 132. In other words, feed-back can not be made for correcting the entrance space for stacking a mail piece 60. Therefore, when it is intended to continuously stack mail pieces which are not uniform in thickness, the stacking state becomes unstable, giving rise to possible jamming.

A still further problem residing in the stacking unit 130 is that a mail piece 60 is pulled in a state that it is in contact with the precedingly stacked mail piece 60, resulting in faint and patchy canceling.

The stacking unit 130 has a yet further problem that when a stacked mail piece 60 slips on the bottom member 131, the position and angle of the mail piece 60 are deviated, giving rise to disturbance of the stacking state.

### SUMMARY OF THE INVENTION

The present invention has been made in order to solve the above problems, and its object is to provide a mail canceling apparatus and mail stacking apparatus capable of maintaining stable stacking state irrespective of the size, the thickness, the bending hardness and the thickness non-uniformity of canceled mail pieces and securing large stacking volume.

According to an aspect of the present invention, there is provided a mail canceling apparatus comprising a feeder unit for feeding out mail pieces, a canceling unit for canceling the fed-out mail pieces, a stacking unit for stacking the canceled mail pieces and a control unit for determining a canceling position through feeding control, wherein: the stacking unit includes a rotor having circumferencially projecting extensions and caused to undergo rotation in response to the detection of entrance of a mail piece. With this arrangement, the extension is caused to undergo rotation into contact with the entering mail piece to move the mail piece to the downstream side. Thus, it is possible to secure the entrance space for the newly entering mail piece and reduce the possibility of occurrence of jamming. Also, since it is unnecessary to adopt the pull-in type roller system, it is possible to prevent the undesired result that the mail piece touches and is damaged by the roller which is rotating at all times.

A pinch roller arrangement for correcting bending of mail pieces is disposed at the inlet of the stacking unit. With this arrangement, even the mail pieces which are bent or tending to be bent can be stacked by correcting the bending.

A guide having an opening such as not to prevent rotation of the extensions and serving to guide the mail pieces is provided on the downstream side of the rotor. With this arrangement, the newly entering mail piece can be guided without preventing the rotation of the extension, and it is possible to further reduce the possibility of occurrence of jamming.

A position sensor for detecting the rotational position of the rotor is provided. With this arrangement, it is possible to provide such control that the extension is not found in the entrance space when a mail piece enters the stacking unit, causing further reliable entrance space.

A bottom member on which the mail pieces are stacked is provided at a position lower in level than the inlet of the stacking unit. With this arrangement, the canceled mail piece can enter the stacking unit without touching the precedingly stacked mail piece.

A stacking pressure sensor for detecting the stacking pressure on each of the mail pieces by using the rotor is provided. With this arrangement, even mail pieces having non-uniform thickness can be continuously stacked.

The stacking unit includes stacking belt means for moving the stacked mail pieces. With this arrangement, it is possible to cause smooth movement of even heavy mail pieces and thus stack a large volume of mail pieces.

The stacking belt means includes a first stacking belt means provided on the bottom member on the upstream side thereof, and a second stacking belt means provided to be continuous to the first stacking belt means and moved at a speed lower than the first stacking belt means. With this arrangement, it is possible to stack the mail pieces in a compact state so that no clearance is formed on the bottom side of the stacked mail pieces.

The second stacking belt means has ridge means for engaging the mail pieces. With this arrangement, the stacked mail pieces can be held in that state, and it is thus possible to prevent such undesired results as deviation of the position and angle of mail pieces and disturbance of the stacking state and obtain continuous stacking without occurrence of jamming.

The bottom member has a downstream side part higher in level than the second stacking belt means. With this arrangement, it is possible readily move the stacked mail pieces for such purposes as shifting the mail pieces to a separate box or the like.

According to another aspect of the present invention, there is provided a mail stacking apparatus for stacking mail pieces comprising: a detector for detecting entrance of a mail piece; and a stacking unit which includes a rotor having circumferencially projecting extensions and is caused to undergo rotation in response to the detection of entrance of the mail piece.

A pinch roller arrangement for correcting bending of mail pieces is disposed at the inlet of the stacking unit. A guide having an opening such as not to prevent rotation of the extensions and serving to guide the mail pieces is provided on the downstream side of the rotor. A position sensor for detecting the rotational position of the rotor is provided. A bottom member on which the mail pieces are stacked is provided at a position lower in level than the inlet of the stacking unit. A stacking pressure sensor for detecting the stacking pressure on each of the mail pieces by using the rotor is provided. The stacking unit includes stacking belt means for moving the stacked mail pieces. The stacking belt means includes a first stacking belt means provided on the bottom member on the upstream side thereof, and a second stacking belt means provided to be continuous to the first stacking belt means and moved at a speed lower than the first stacking belt means. The second stacking belt means has ridge means for engaging the mail pieces. The bottom member has a downstream side part higher in level than the second stacking belt means.

Other objects and features will be clarified from the following description with reference to attached drawings.

### BRIEF DESCRIPTION OF THE DRAWINGS

FIGS. 1(a) to 1(c) are schematic views showing a plan view, a front view and a side view, for explaining the overall structure of an embodiment of the mail canceling apparatus according to the present invention;

FIG. 2 is a schematic perspective view for explaining the structure of the stacking unit in the embodiment of the mail canceling apparatus;

FIGS. 3(a) to 3(c) are schematic views of the stacking unit in the embodiment according to the present invention, FIG. 3(a) being a sectional view in the state where the mail pieces is entrancing, FIG. 3(b) being a sectional view in the state where the mail pieces is stacked, and FIG. 3(c) being a sectional view in the state where the entrance space is secured;

FIGS. 4(a) and 4(b) are schematic views of the stacking unit in the embodiment according to the present invention, FIG. 4(a) being a surface view before entrance of the mail pieces, and FIG. 4(b) being a surface view in the state where the mail pieces is stacked;

FIG. 5 is a schematic sectional view of the second stacking belts in the embodiment according to the present invention;

FIGS. 6(a) and 6(b) are schematic views of the stacking unit in the embodiment according to the present invention, FIG. 6(a) being a sectional view where the mail pieces are fully stacked, and FIG. 4(b) being a sectional view in the state where the paddle is moved toward the upstream side; and

FIG. 7 is a schematic top view for explaining a pull-in roller type stacker in a prior art mail canceling apparatus.

### PREFERRED EMBODIMENTS OF THE INVENTION

Preferred embodiments of the present invention will now be described with reference to the drawings.

Although the following embodiment will be made with an embodiment of mail canceling apparatus, the present invention can, of course, apply to a mail stacking apparatus.

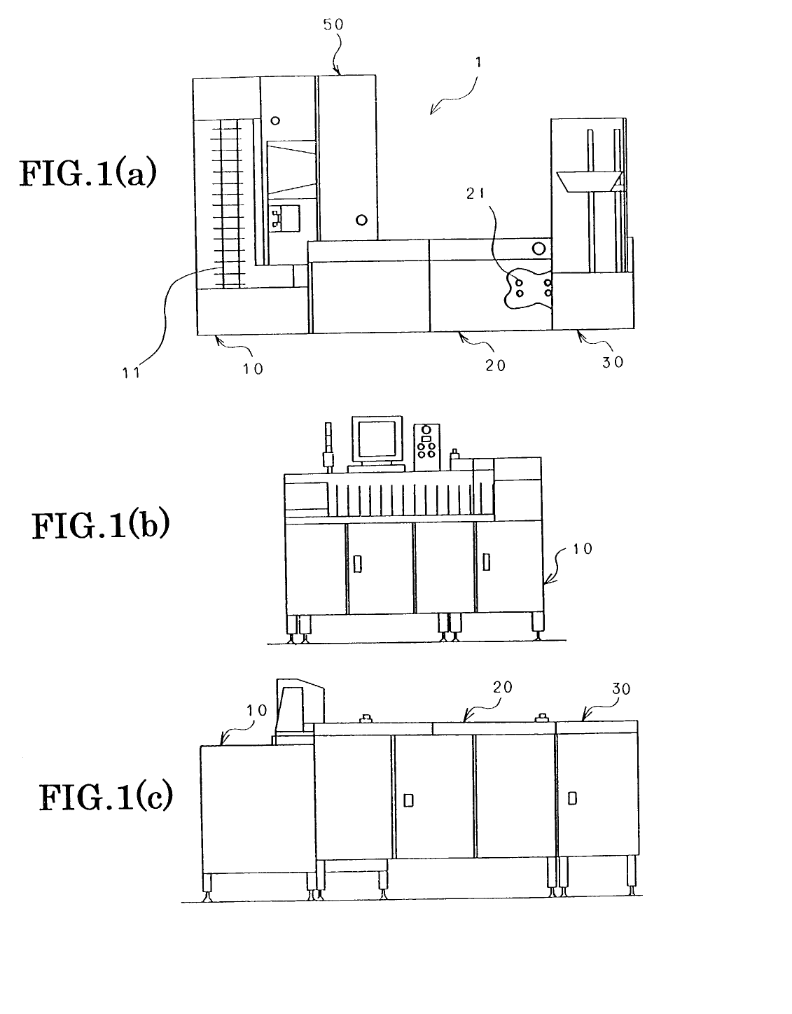

FIGS. 1(a) to 1(c) are schematic views, FIG. 1(a) being a plan view, FIG. 1(b) being a front view and FIG. 1(c) being a side view, for explaining the overall structure of an embodiment of the mail canceling apparatus according to the present invention. Referring to the Figure, the mail canceling apparatus 1 comprises a feeder unit 10, a canceling unit 20, a stacking unit 30 and a control unit 50 for executing feeding control to determine a canceling position.

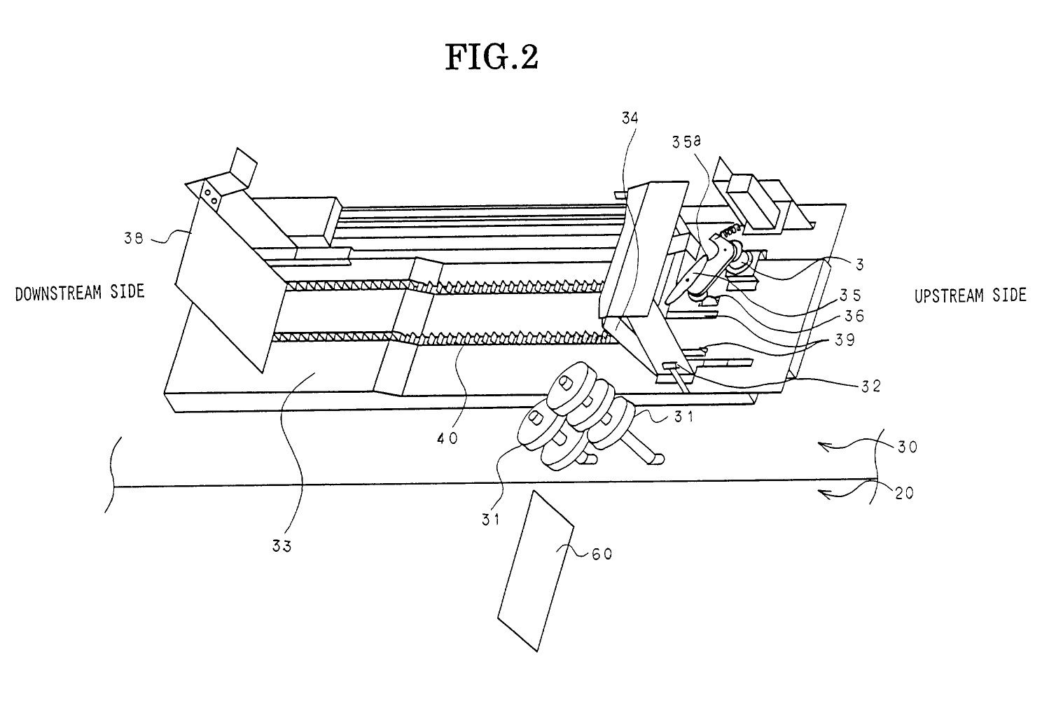

FIG. 2 is a schematic perspective view for explaining the structure of the stacking unit in the embodiment of the mail canceling apparatus.

Referring to the Figure, the stacking unit 30 includes a pinch roller arrangement 31, an entrance sensor 32, a bottom member 33 with mail pieces 60 placed thereon, a guide 34, a rotor 35, a position sensor 36 for detecting the rotational position of the rotor 35, a depression sensor 37 for detecting the depression of the rotor 35, a paddle 38, first stacking belts 39 and second stacking belts 40.

The pinch roller arrangement 31 has a face-to-face structure having a plurality of rollers disposed between the canceling unit 20 and the bottom member 33 such as to clamp mail pieces 60 in a staggered fashion. In this embodiment the pinch roller arrangement 31 uses two pinch roller sets 31 one having two rollers and the other having three rollers. Although not shown, the two pinch roller sets 31 are both rotatable for clamping and feeding mail pieces 60 fed from the canceling unit 20.

With this arrangement, the pinch roller arrangement 31 permits stacking even bent or tending-to-bend mail pieces 60 in a bend-corrected state.

At least one of the pinch roller set 31 is capable of being moved, in a state that it is biased in the direction of clamping a mail piece 60 such as to increase the distance between the two pinch roller sets 31 when the mail piece 60 to be stacked is thick. Thus, it is possible to cope with mail pieces 60 having different thicknesses.

The pinch roller arrangement 31 may be made of a soft material such as sponge rubber. In this case, the pinch roller arrangement 31 can feed a mail piece 60 while being deformed based on the thickness of the mail piece 60. This means that it is possible to fix the distance between the two pinch roller sets 31.

The pinch roller arrangement 31 has a structure of clamping the mail pieces 60 in a staggered fashion with a plurality of rollers. Thus, the two pinch roller sets 31 are normally out of contact with each other, and are brought into contact when and only when a mail piece 60 is clamped. It is thus possible to reduce wear of the pinch roller sets 31. The structure of the pinch roller arrangement 31 as shown is by no means limitative; for instance, it is possible to provide the same number of rollers in both the sets.

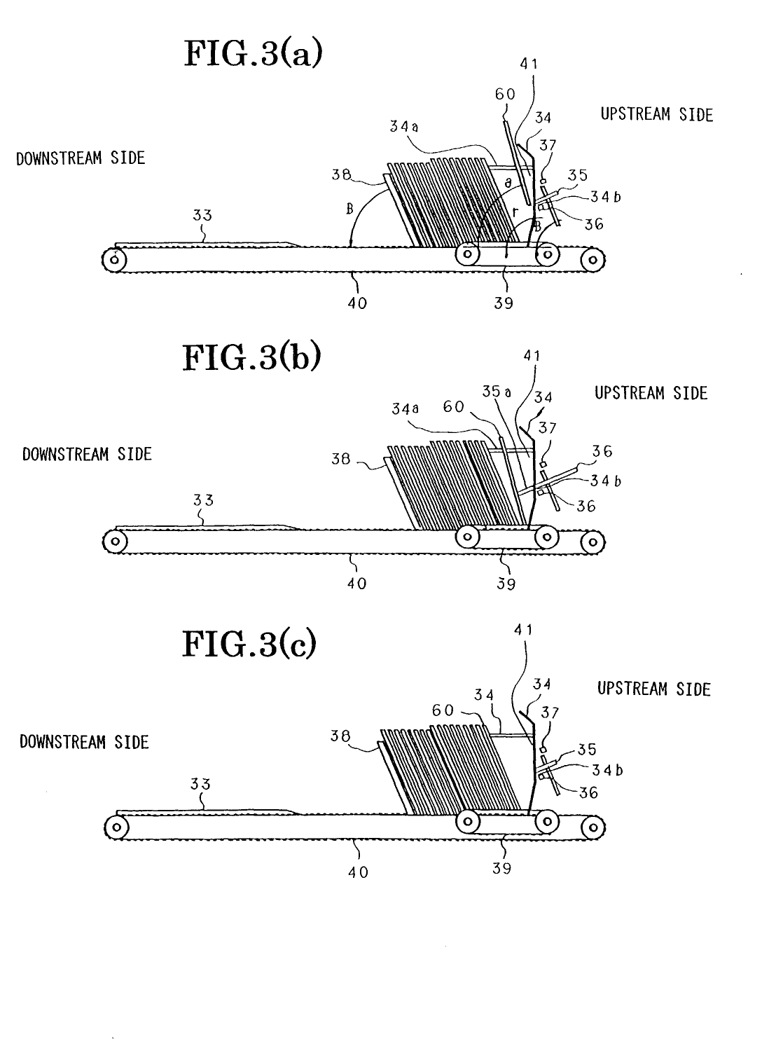

As shown in FIGS. 3(a) to 3(c), the pinch roller arrangement 31 is disposed such that the entrance position and the entrance angle of a mail piece 60 are appropriate so that the mail piece 60 can smoothly enter substantially the center of an entrance space 41. By the term “entrance space” is meant a space between the paddle 38 or a precedingly stacked mail piece 60 and the guide 34.

As shown in FIG. 3(a), preferably the projection angle α of the pinch roller arrangement 31 is set to be greater than the inclination angle β of the paddle 36 and less than the projection angle γ of the guide 34. With this arrangement, mail pieces 60 can reliably enter the entrance space 41 without touching the precedingly stacked mail piece 60 to the guide 34 and irrespective of its bending hardness. This is so because with the setting of the projection angle a to be greater than the inclination angle β it is possible to reduce the possibility of contact of the mail piece 60 with the precedingly stacked mail piece 60 and also with the setting of the projection angle α less than the projection angle γ it is possible to reduce the possibility of contact of the mail piece 6 with the guide 34.

The bottom member 33 on which the mail pieces 60 are stacked, are disposed at a position lower in height level than the inlet of the stacking unit 30. With this arrangement, the mail piece 60 moves through the entrance space 41 and falls onto the bottom member 33 by drawing a parabola, which is determined by the feed-out speed of the pinch roller arrangement 31 and the distance between the feed-out position of the pinch roller arrangement 31 to the bottom member 33. Thus, a mail piece 60 having been canceled in the canceling unit 20 can enter the entrance space 41 in the stacking unit 30 without touching the precedingly stacked mail piece 60 or the guide 34, and it is thus possible to reduce the possibility of contamination of the canceled part.

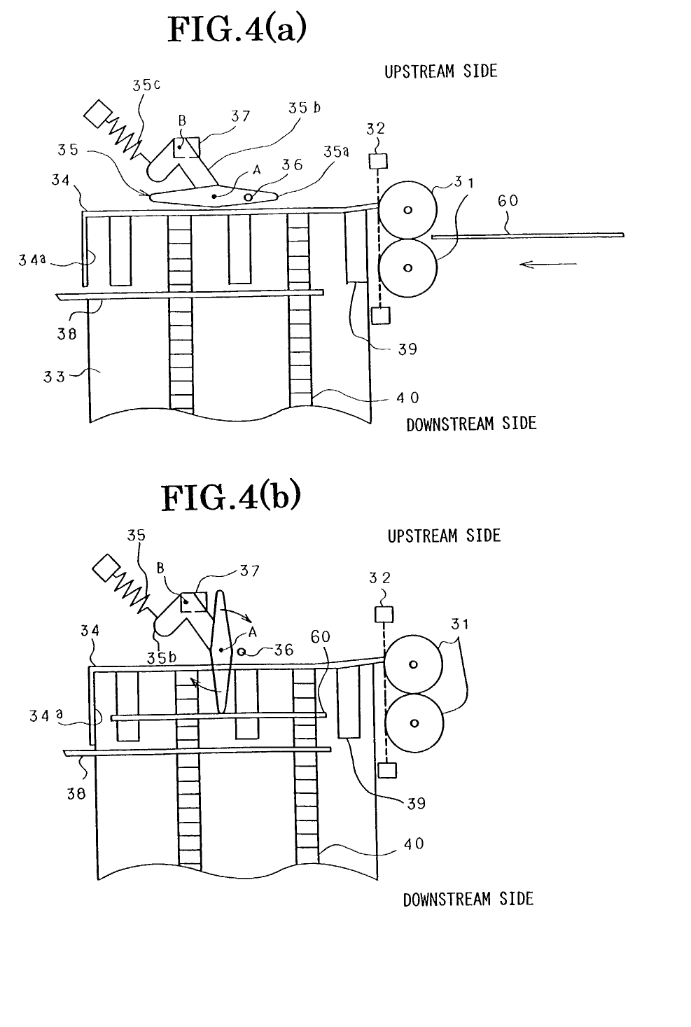

The guide 34 is provided on the upstream side of the bottom plate 33, and detects the entrance space 41. The guide 34 has a stopper 34a extending from its end opposite the pinch roller arrangement 31 and serving to stop a vigorously fed-out mail piece 60 lest the mail piece 60 should fly out from the bottom member 33 (see FIG. 4).

The guide 34 has a horizontally elongate opening 34b formed substantially in its center such that an extension 35a of the rotor 35 can project through the opening 34b in dependence on its rotational position.

Thus, the guide 34 does not prevent the rotation of the extension 35a owing to the opening 34b, and serves as a guide for guiding a mail piece 60. That is, the guide 34 can guide a new mail piece 60 entering the entrance space, and thus reduce the possibility of occurrence of jamming.

The rotor 35 as shown in FIG. 2 has two circumferencially projecting blade-like extensions 35a. As shown in FIG. 3, while the rotor 35 is stationary, its extensions 35a are found on the upstream side of the guide 34. When the rotor 35 is rotated, an extension 35a projects through the opening 34b of the guide 34. The rotor 35, like the paddle 38, is further provided at inclination angle β on the upstream side of the bottom member 33.

Thus, while its extensions 35a are located on the upstream side (i.e., inner side) of the guide 34 (see FIGS. 3(a) and 4(b)), the entrance of the mail piece 60 is not prevented. That is, the mail piece 60 can smoothly enter the entrance space 41 without touching the extension 35a.

When it is detected that a mail piece 60 is going to enter, the rotor 35 is caused to rotate in the same direction as the direction of entering of the mail piece 60, and with the projection of the extension 35a to the outside of the guide 34 (see FIGS. 3(b) and 4(b)), it can stop the mail piece 60 such as to prevent fling-back thereof from the stopper 34a and also push the entered mail piece 60 to the downstream side to be stacked on the precedingly stacked mail piece 60.

An entrance sensor 32 such as an optical sensor is provided between the pinch roller arrangement 31 and the rotor 35. When the entrance sensor 32 detects the entrance of the mail piece 60, it outputs an entrance detection signal to the control unit 50.

The controller unit 50 calculates the leading end position of the mail piece 60 based on the received entrance detection signal and the rotational speed of the pinch roller sets 31 and, when the leading end of the mail piece 60 reaches a position corresponding to the center of rotation of the rotor 35, it causes clockwise rotation of the rotor 35 as shown in FIGS. 3(b) and 4(b).

When the rotation of the rotor 35 is caused, the extension 35a thereof flaps the mail piece 60 to cause movement thereof to the downstream side.

Preferably a position sensor 36 for detecting the rotational position of the rotor 35 is provided. By so doing, when a new mail piece 60 enters the entrance space 41, the extension 35a can be accurately controlled such that it will not be positioned in the entrance space 41, thus securing the entrance space.

The rotor 35 is provided on one end of a rotatably supported hook-like rocking member 35b. Thus, as shown in FIGS. 4(a) and 4(b), the rotor 35 undergoes rotation about point A, and when the rocking member 35b undergoes rotation about point B by a given angle, it rocks relative to the guide 34.

The rocking member 35b is biased by a spring 35c such as to bias the rotor 35 to the downstream side. Thus, when no clearance is formed between adjacent the stacked mail pieces 60 so that the extension 35a can not push the entering mail piece 60 to the downstream side, the rotor is moved to the upstream side. On the other hand, when a clearance is formed between adjacent stacked mail pieces 60 so that the extension 35a can push the entering mail piece 60 to the downstream side, the rotor 35 is not moved to the upstream side.

This means that the rotor 35 can stack mail pieces 60 with stacking pressure corresponding to the tensile force of the spring 35c. Thus, when the mail pieces 60 handled are heavy, for instance, the tensile force of the spring 35c is increased. By so doing, the rotor 35 push the mail pieces 60 with an increased force to the downstream side.

The stacking pressure sensor 37 is adapted to detect the stacking pressure on the mail pieces 60 from the tensile force of the spring 35c.

When the rotor 35 is not moved, the extension 35a of the rotor 35 pushes the mail pieces 60 with a stacking pressure less than the tensile force of the spring 35c.

When a thick mail piece 60, for instance, enters while no clearance is formed between adjacent stacked mail pieces 60, the rotor 35 rocks greatly when its rotation is caused. This means that the stacking pressure sensor 37 can detect the state of stacking of mail pieces 60 as well. In such case, the first and second stacking belts 39 and 40 are caused to undergo excursion according to the extent of rocking of the rotor 35, thus securing the entrance space 41 (see FIG. 3(c)). With this arrangement, even mail pieces 60 having non-uniform thicknesses can be continuously stacked.

As shown above, the rotor 35 secures the entrance space 41 by flapping the entering mail piece 60, and it is thus possible to reduce the possibility of occurrence of jamming. Also, since no pull-in roller system is adopted, it is possible to prevent such undesired result as damage caused to a mail piece 60 in contact with the roller, which is rotating at all times.

While the rotor 35 has a structure that it has two extensions 35a, this structure is by no means limitative, and it is possible as well to provide a single or three or more extensions 35a.

The rotor 35 may also be adopted to be operable such that with entrance of a mail piece 60 it undergoes rotation such that its extension 35a projects through the guide 34 to stop the mail piece 60 such that the mail piece 60 will not fling back from the stopper 34a and that its extension projects through the guide 34 once again to push the entered mail piece to the downstream side. With this arrangement, it is possible to reliably carry out individual operations.

The first stacking belts 39 are disposed on the bottom member 33 on the upstream side thereof and, as shown in FIG. 3, are located at a position higher in level than the second stacking belts 40. Thus, in the initial stage of stacking, the mail pieces 60 are resting on the first stacking belts 39 and are eventually shifted to the second stacking belts. In this way, the mail pieces 60 can be moved continuously.

Preferably the speed of movement of the first stacking belts 39 is set to be higher than the speed of movement of the second stacking belts 40. In this case, the mail pieces 60 entering the stacking unit 30 can be stacked in a compact state without any clearance formed on the bottom member side.

With the provision of the stacking belts 39 and 40, even heavy mail pieces 60 can be smoothly moved, and it is possible to stack a large quantity of mail pieces 60.

In this embodiment, the first stacking belts 39 have a flat surface free from irregularities. Thus, the stacking state of mail pieces 60 right after stacking can be readily corrected and made uniform, and these mail pieces 60 thus can be shifted in a neat state to the second stacking belts 40. Also, it is possible to reduce wear and damage that may be caused to mail pieces 60 by the first stacking belts 39.

In this embodiment, two parallel second stacking belts 40 are disposed on the bottom member 33 to extend from the upstream side to the downstream side thereof.

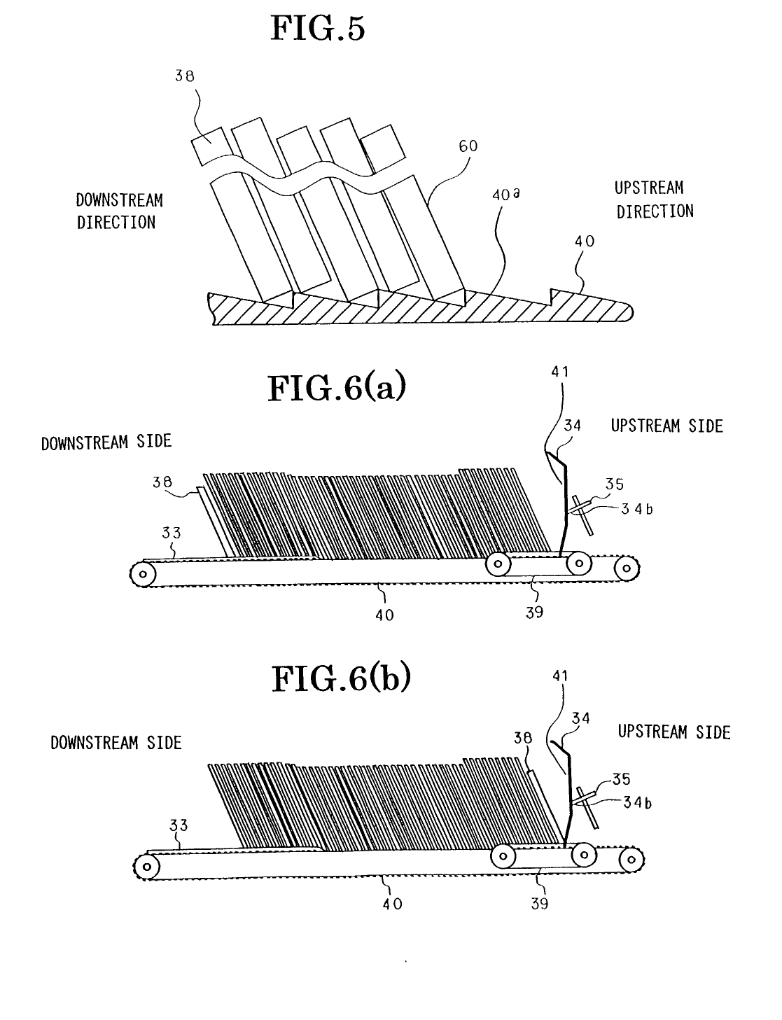

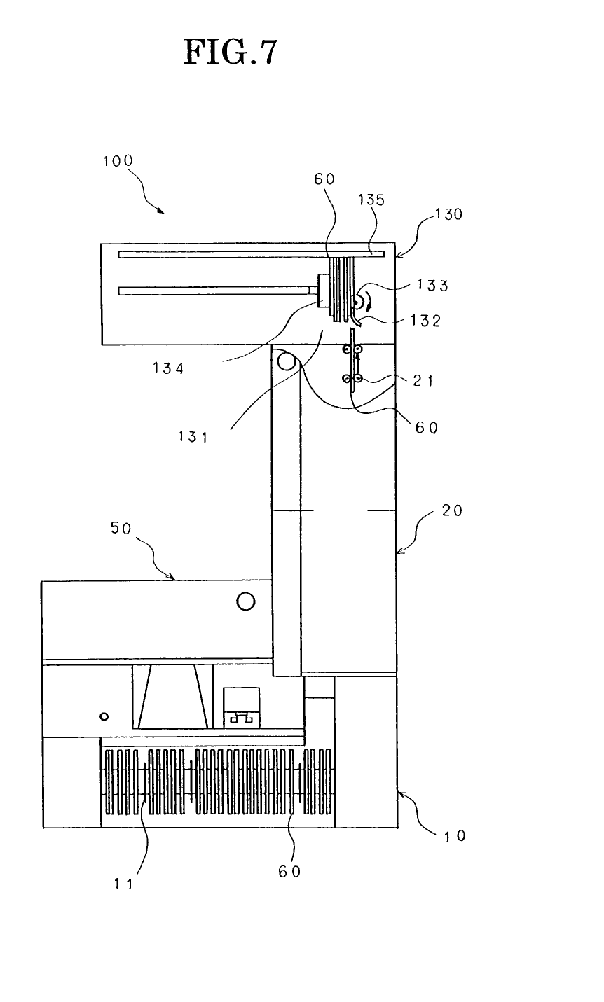

As shown in FIG. 5, the second stacking belts 40 preferably have ridges 40a to prevent slip of the bottom part of mail pieces 60 toward the upstream side. With this arrangement, stacked mail pieces 60 can be held in that state. It is thus possible to prevent such undesired results as deviation of the position and angle of the mail pieces 60 and resultant disturbance of the stacking state, thus permitting continuous stacking without possibility of occurrence of jamming.

Furthermore, with the bottom part of the paddle 38 engaged by a ridge 40a, the movement of the paddle 38 can be assisted.

More preferably, the ridges 40a of the second stacking belt 40 have a triangular cross-sectional profile such as to make slip toward the upstream side difficult. This shape of the ridges 40a has an effect of preventing a mail piece 60 brought to rest on the slanted top surface of the triangle from turning down by clearing the top corner, and it is thus possible to maintain the stacking state. Also, it is made possible to readily move mail pieces 60 from the upstream side to the downstream side, thus permitting the stacked mail pieces 60 to be readily shifted to a separate box or the like.

As shown in FIGS. 6(a) and 6(b), preferably a downstream side part of the bottom member 33 is made to be higher in level than the second stacking belts 40.

With this arrangement, upstream side mail pieces 60 among the stacked mail pieces 60 are moved in unison with the second stacking belts 40 they rest thereon, while downstream side mail pieces 60 are moved while sliding over the pertinent part of the bottom member 60, which is higher in height level than the second stacking belts 40. It is thus possible to readily move the downstream side mail pieces 60 in such case as when shifting the stacked mail pieces 60 to a separate box or the like.

The paddle 38 is adapted to be reciprocable along the bottom member 33 between the upstream and downstream sides thereof in a state that it is detachably supported on a guide rail 38a.

The paddle 38 is also engaged by ridges 40a of the second stacking belts 40 for movement in an interlocked relation or synchronism to the second stacking belts 40, thus permitting reliable stacking of mail pieces 60.

Furthermore, as shown in FIG. 2, the paddle 38 rests on the second stacking belts until reaching of a full stacking volume and thus can hold mail pieces 60 until the end of the stacking cycle.

Other structures and functions of the embodiment of the mail canceling apparatus are the same as those of the prior art mail canceling apparatus 100.

Now, operations and functions of the mail canceling apparatus 1 having the above construction will be described.

In the canceling unit 20, a feed roller set 21 feeds canceled mail pieces 60 to the pinch roller arrangement 31 provided at the inlet of the stacking unit 30.

The pinch roller arrangement 31 feeds out the mail pieces 60 while correcting the bending thereof to the entrance space 41.

Since the feed-out level of the pinch roller arrangement 31 is higher than the bottom member 33, the mail pieces 60 fall while drawing a parabola, thus entering the entrance space 41.

As shown in FIG. 3(a) and 4(a), the extension 35a of the rotor 35 is normally found on the upstream side of the guide 34, it does not prevent the entrance of each canceled mail piece 60. Each mail piece 60 thus enters the stacking unit 30 without touching the precedingly stacked mail piece 60.

Also, since the projection angle α of the pinch roller arrangement 31 is set to be greater than the inclination angle β of the paddle 36 and less than the projection angle γ of the guide 34, the mail piece 60 can reliably enter the entrance space 41 without touching the precedingly stacked mail piece 60 or the guide 34.

When the entrance sensor 32 detects the entrance of the mail piece 60, it outputs an entrance detection signal to the control unit 50.

The control unit 50 calculates the leading end position of the mail piece 60 according to the received entrance detection signal and the rotational speed of the pinch roller arrangement 31. When the leading end of the mail piece 60 reaches a position corresponding to the center of rotation of the rotor 35, as shown in FIG. 4(b), the rotor 35 is rotated clockwise to flap the mail piece 60 and also move the mail piece 60 to the downstream side, as shown in FIGS. 3(c) and 4(c).

When one rotation 35 is brought about, the mail piece 60 is flapped twice by the respective extensions 35a, so that the mail piece 60 can be reliably moved to the downstream side.

The position sensor 36 is detecting the rotational position of the rotor 35, and permits control of the position of the extensions 35a and the rotational speed thereof.

As shown in FIGS. 4(a) and 4(b), the rotor 35 undergoes rotation about point A and rocking about point B.

The rotor 35 is biased by the rocking member 35b, which is in turn biased by the spring 35c. The stacking pressure on the mail piece 60 thus can be controlled by adjusting the tensile force of the spring 35c. For example, when the mail pieces 60 handled are heavy, the tensile force may be increased. By so doing, the extension 35a can push the mail piece 60 with a greater force to the downstream side.

The stacking pressure sensor 37 detects the stacking pressure on the mail piece 70 by detecting the rocking angle of the rotor 35.

When the stacking pressure sensor 37 detects a predetermined stacking pressure at the time of the flapping of the mail piece 60 by the rotor 35, the first and second stacking belts 39 and 40 are caused to undergo excursion to the downstream side.

Since the first stacking belts 39 undergo faster excursion than the second stacking belts 40, the mail pieces can be stacked compactly so that no clearance will be formed on the bottom side of the mail pieces 60.

As shown in FIG. 3(c), in the stacking unit 30 the entrance space 41 is thus secured for a newly entering mail piece 60. It is thus possible to stack the mail piece 60 without possibility of occurrence of jamming.

As shown in FIG. 6(a), in the mail canceling apparatus 1, the stacking of mail pieces 60 proceeds up to or nearly up to the full volume, this is notified to the operator by turning-on of a lamp or generation of a buzzer sound, while feeding of mail pieces from the feeder unit 10 is automatically interrupted.

Of the stacked mail pieces 60, those on the upstream side rest on and are moved in unison with the second stacking belts 40, while those on the downstream side 60 are moved while sliding on the bottom member 33.

The paddle also rests on and is moved in synchronism with the second stacking belts 40.

The paddle 38 rests on the second stacking belts even along the downstream side increased height level part of the bottom member 33, and thus it can hold the mail pieces 60 up to the end of the stacking cycle.

As shown in FIG. 6(b), after the end of the stacking cycle the operator brings the paddle 38 back to the initial position, shifts the mail pieces 60 on the downstream side of the paddle 38 now in the initial position to a separate box or the like for the next stacking cycle, and starts the mail canceling apparatus 1 again.

Other operations and functions are the same as in the prior art mail canceling apparatus 100.

As has been described in the foregoing, with the mail canceling apparatus according to the present invention it is possible to maintain stable stacking state and secure a large stacking volume irrespectively of the size, the thickness, the bending hardness and thickness non-uniformity of the printed mail pieces.

In addition, in the stacking unit the mail piece is flapped by the rotor in synchronism to the timing of its entrance to secure the entrance space of the next mail piece, and it is thus possible to reduce jamming (or defective stacking).

Furthermore, in the stacking unit, the stacking pressure sensor detects the stacking pressure on or the posture of the mail piece, and the first and second stacking belts are caused to undergo excursion in accordance with the detected stacking pressure and posture. Thus, it is possible to secure a fixed entrance space at all times even with mail pieces of non-uniform thicknesses and continuously stack mail pieces of non-uniform thicknesses.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A mail canceling apparatus comprising a feeder unit for feeding out mail pieces, a canceling unit for canceling the fed-out mail pieces, a stacking unit for stacking the canceled mail pieces and a control unit for determining a canceling position through feeding control, wherein:
the stacking unit includes a rotor having circumferencially projecting extensions and caused to undergo rotation in response to the detection of entrance of a mail piece.

2. The mail canceling apparatus according to claim 1, wherein a pinch roller arrangement for correcting bending of mail pieces is disposed at the inlet of the stacking unit.

3. The mail canceling apparatus according to claim 1, wherein a guide having an opening such as not to prevent rotation of the extensions and serving to guide the mail pieces is provided on the downstream side of the rotor.

4. The mail canceling apparatus according to claim 1, wherein a position sensor for detecting the rotational position of the rotor is provided.

5. The mail canceling apparatus according to claim 1, wherein a bottom member on which the mail pieces are stacked is provided at a position lower in level than the inlet of the stacking unit.

6. The mail canceling apparatus according to claim 1, wherein a stacking pressure sensor for detecting the stacking pressure on each of the mail pieces by using the rotor is provided.

7. The mail canceling apparatus according to claim 1, wherein the stacking unit includes stacking belt means for moving the stacked mail pieces.

8. The mail canceling apparatus according to claim 7, wherein the stacking belt means includes a first stacking belt means provided on the bottom member on the upstream side thereof, and a second stacking belt means provided to be continuous to the first stacking belt means and moved at a speed lower than the first stacking belt means.

9. The mail canceling apparatus according to claim 8, wherein the second stacking belt means has ridge means for engaging the mail pieces.

10. The mail canceling apparatus according to claim 9, wherein the bottom member has a downstream side part higher in level than the second stacking belt means.

11. A mail stacking apparatus for stacking mail pieces comprising:
a detector for detecting entrance of a mail piece; and
a stacking unit which includes a rotor having circumferencially projecting extensions and is caused to undergo rotation in response to the detection of entrance of the mail piece.

12. The mail stacking apparatus according to claim 1, wherein a pinch roller arrangement for correcting bending of mail pieces is disposed at the inlet of the stacking unit.

13. The mail stacking apparatus according to claim 11, wherein a guide having an opening such as not to prevent rotation of the extensions and serving to guide the mail pieces is provided on the downstream side of the rotor.

14. The mail stacking apparatus according to claim 11, wherein a position sensor for detecting the rotational position of the rotor is provided.

15. The mail stacking apparatus according to claim 11, wherein a bottom member on which the mail pieces are stacked is provided at a position lower in level than the inlet of the stacking unit.

16. The mail stacking apparatus according to claim 11, wherein a stacking pressure sensor for detecting the stacking pressure on each of the mail pieces by using the rotor is provided.

17. The mail stacking apparatus according to claim 11, wherein the stacking unit includes stacking belt means for moving the stacked mail pieces.

18. The mail stacking apparatus according to claim 17, wherein the stacking belt means includes a first stacking belt means provided on the bottom member on the upstream side thereof, and a second stacking belt means provided to be continuous to the first stacking belt means and moved at a speed lower than the first stacking belt means.

19. The mail stacking apparatus according to claim 18, wherein the second stacking belt means has ridge means for engaging the mail pieces.

20. The mail canceling apparatus according to claim 19, wherein the bottom member has a downstream side part higher in level than the second stacking belt means.
